(19) United States
(12) Patent Application Publication
(10) Pub. No.: US 2002/0040866 A1
(43) Pub. Date: Apr. 11, 2002

(54) Method and apparatus for displaying information

(76) Inventors: Mats Tuneld, Shanghai (CN); Hao Ling, Shanghai (CN); Hong Zhu, Shanghai (CN); Jiongming Pi, Shanghai (CN); Xiaoling Shao, Shanghai (CN); Li Weng, Shanghai (CN); Malin Larsson, Shanghai (CN)

Correspondence Address: JENKENS & GILCHRIST, PC, 1445 ROSS AVENUE, SUITE 3200, DALLAS, TX, 75202, US

(21) Appl. No.: 09/864,720

(22) Filed: May 24, 2001

(30) Foreign Application Priority Data
May 26, 2000 (CN) PCT/CN00/00132
May 10, 2001 (CN) PCT/CN03/00732

(51) Int. Cl. B07C 5/00

(52) U.S. Cl. 209/546; 209/548; 209/933

(57) ABSTRACT

The present invention relates to a method and an apparatus for displaying text information in different sort orders. The method comprises the steps of selecting one of a plurality of sort order criteria; sorting a plurality of string objects based on the selected sort order; and displaying the string objects in selected sort order. The string objects may further be divided into groups, and the string objects of the selected group are displayed in a manner that is different from the manner of displaying the string objects of other groups or the cursor is move to the location of string objects of the selected group. The user may use different sort orders and groups to find out the desired record.

### BACKGROUND OF THE INVENTION

1. Technical Field

The present invention relates generally to a method and an apparatus for displaying information, and in particular to a method and an apparatus for displaying text information in different sort orders.

2. Description of Related Art

Along with the development of digital technique and Internet, more and more information is processed and displayed digitally. For Example, in many personal computers (PC), personal digital assistants (PDA) and mobile phones, there is a built-in digital address book recording a lot of personal contact information, such as name, address, telephone number etc. When a user wants to find a record in the address book, usually all the records are sorted and displayed in an order. If the records are English, they are displayed in alphabetically, and the user can scroll the list to find the record he or she wants. In the case of Chinese, one of the solutions of the art is that the records are listed in Pinyin order of the records, such as the address book in Netscape Communicator. A similar solution is sorting and displaying in the Zhuyin order, such as the address book of Lotus Organizer (Traditional Chinese Version). In the address book of Microsoft Outlook (Simplified Chinese Version), the letters of Pinyin are mapped into buttons. When a button is pressed, the records beginning with the letter of this button are sorted and displayed. Another solution of the art is sorting the records according to the strokes, for example, the address book of GSL PDA 3000.

The defect of the above solutions is that it is not flexible to sort the Chinese information in just one order. English information may be clearly sorted in alphabetical order. However, if Chinese information is sorted in just one order, the user must be familiar with this order. For example, while sorting in Pinyin order, the user must know the correct Pinyin of every Chinese character. But it is difficult for some Chinese to learn the correct Pinyin because of their accent. Some regions of China, such as Taiwan, use Zhuyin, which is different from Pinyin. Therefore, these people cannot use Pinyin order to find out the desired record easily.

Therefore, it would be advantageous to have a flexible method for displaying Chinese text so that the user may use the sort order that he/she is familiar with to find out the desired record easily and quickly.

The object of the present invention is to provide a method for displaying a plurality of Chinese strings in different sort order. The sorted strings are further divided into groups so that the user may search the desired string more quickly.

### SUMMARY OF THE INVENTION

The present invention provides a method for displaying information comprising of the steps of selecting one of a plurality of sort order criteria; sorting a plurality of string objects based on the selected sort order of the string objects;and displaying the string objects in the selected sort order.

The present invention also provides an apparatus for displaying information comprising a storage means for storing a plurality of string objects; an input means for selecting user commands; a sorting means for responding to the sort order criteria selected by a user, retrieving a plurality of the string objects from said storage device, and sorting the string objects based on the selected sort order of the string objects; and a display means for displaying the string objects in the selected order.

### BRIEF DESCRIPTION OF THE DRAWING

The invention itself as well as further objectives and advantages there of will be understood by reference to the following detailed description of the embodiments when read in conjunction with the accompanying drawings, wherein:

FIG. 1 is a flowchart of a process for displaying string objects depicted in accordance with one embodiment of the present invention.

FIGS. 2A and 2B are flow charts of a process for displaying string objects depicted in accordance with another embodiment of the present invention.

FIG. 3 is a block diagram illustrating an apparatus in which the present invention may be implemented in accordance with the present invention.

FIGS. 4A-4C are the user interfaces of the present invention.

### DETAILED DESCRIPTION OF THE PREFERRED EMBODIMENT

### Embodiment 1

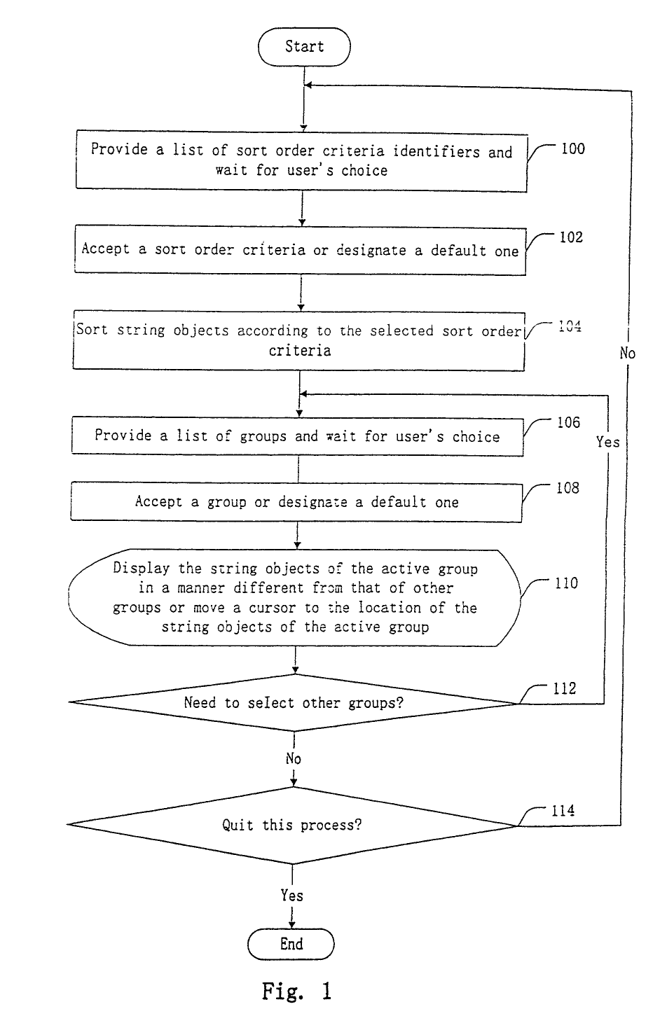

With reference to FIG. 1, a flow chart of a process for displaying string objects is depicted in accordance with one embodiment of the present invention. The process begin sat step 100 where a list of sort order criteria is provided and waits to be selected by the user. These sort order criteria for Chinese may be Pinyin, Zhuyin, stroke, radical, stroke count or other rules of splitting Chinese character. The sort order criteria for Japanese may be kana order, stroke order, or radical order. For Korean, they may be Korean character order, or stroke order. Every sort order criteria may be provided with an identifier, such as a tab, a button or an icon. The user may click on the corresponding identifier to select the desired sort order.

The sort order criteria selected by the user is received at step 102. If the user does not selector it is the first time entering this step, a default sort order criteria may be designated. The default sort order maybe pre-selected by the user or the system (e.g. Pinyin order) or it maybe that which was in place the last time that method was used (i.e. when the system exited last time, the sort order was stroke order, then the default is set to stroke order) or it may be decided by an algorithm (e.g. set the default sort order to the most frequently use done according to the statistic of the usage of sort orders).

At step 104, the string objects are sorted according to the selected sort order criteria. If the sort order is Pinyinor Zhuyin, the string objects are sorted according to the order of character in the criteria dictionary. If the sort order is stroke, radical or other splitting rules, the string objects are sorted in predetermined order of the stroke or section of the string objects.

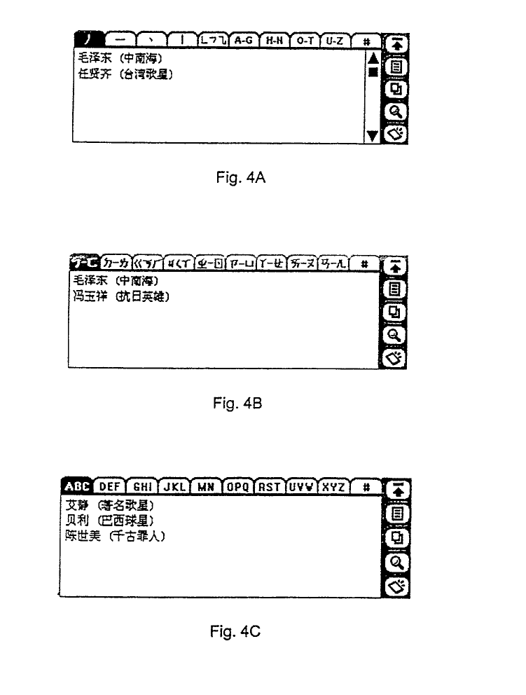

Next in step 106, a group list is provided for the current sort order criteria. Each group may have an identifier, such as a tab, a button or an icon, as shown in FIGS. 4A-AC. For Pinyin order, the groups maybe “ABC”, “DE”, “GHI”, “JKL”, “MN”, “OPQ”, “RST”, “UVW”, “XYZ” and other. For Zhuyin, the groups may be “ [symbol] ”, “ [symbol] ”, “ [symbol] ”, “ [symbol] ”, “ [symbol] ”, “ [symbol] ”, “ [symbol] ”, “ [symbol] ”, “ [symbol] ” and others. For stroke order, the groups may be “ [symbol] ”,“ [symbol] ”, “ [symbol] ”, “ [symbol] ”,“ [symbol] ” and others. For stroke count order, the groups may be “1-5 strokes”, “6-10 strokes”, “11-15 strokes”, “16-20 strokes”, “above 20 strokes” and other. The number of groups in a sort order are decided by the number of identifiers that can be displayed on the screen or the number of objects that included in the groups. For example, when the screen have enough are a to display 10 tabs simultaneously, then the string objects may be divided into 10 groups. They also may be divided so that every group actually has or statistically will have substantially the same number of string objects.

The group selected by the user is received at step 108. If the user does not select or it is the first time entering this step, a default group may be designated. Every sort order has a default group. The default group may be pre-selected by the user or the system or it may be that which was in place the last time that method was used or it may be decided by an algorithm. For example, for Pinyin order, the default group is “ABC”. For stroke order, the default group is “ [symbol] ”. For stroke count order, the default group is “1-5 strokes”. For Zhuyin order, the default group is “ [symbol] ”.

Next, at step 110, the string objects be longing to the selected group are displayed in a manner different from that of other groups, such as the string objects of the selected group are displayed while other objects are hidden, the string objects of the selected group are enlarged, highlighted, blinked, or the font and/or color of the selected group are changed.It is also possible to scroll the list of string objects and move a cursor to location of the first object of the selected group.

There after in step 112, a determination is made as to whether other group need to be selected. If so, the process loops back to step 106. Otherwise, the process goes to step 112 where a determination is made as to whether the process should be stopped. If so, the process stops. Otherwise, the process then returns to step 100.

### Embodiment 2

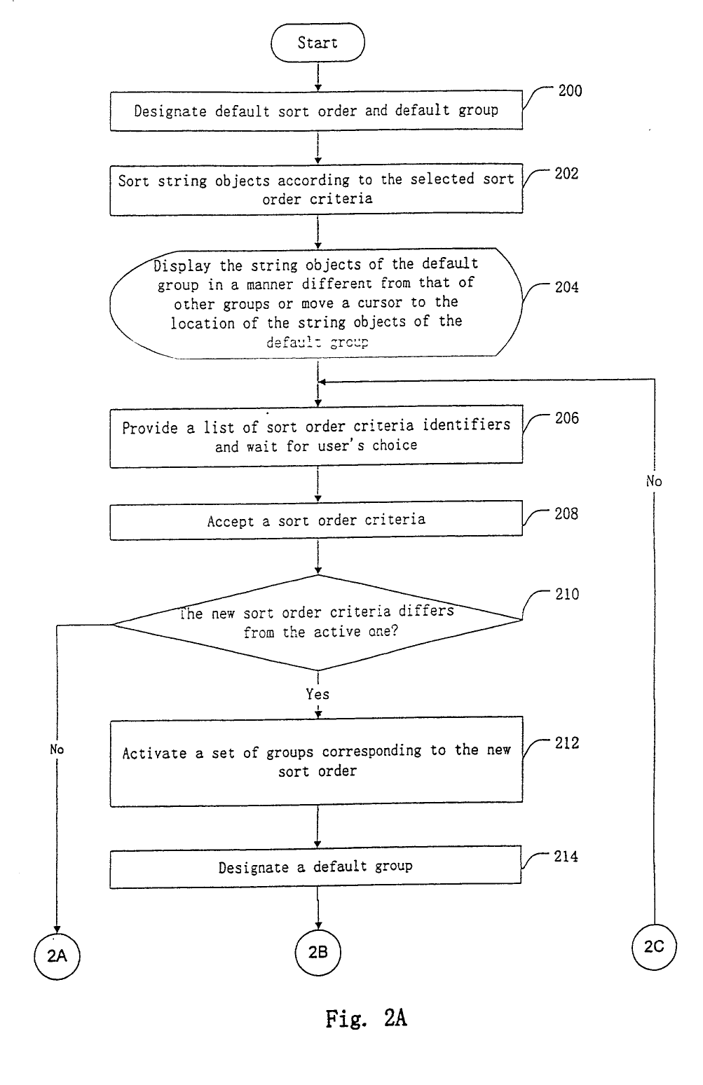

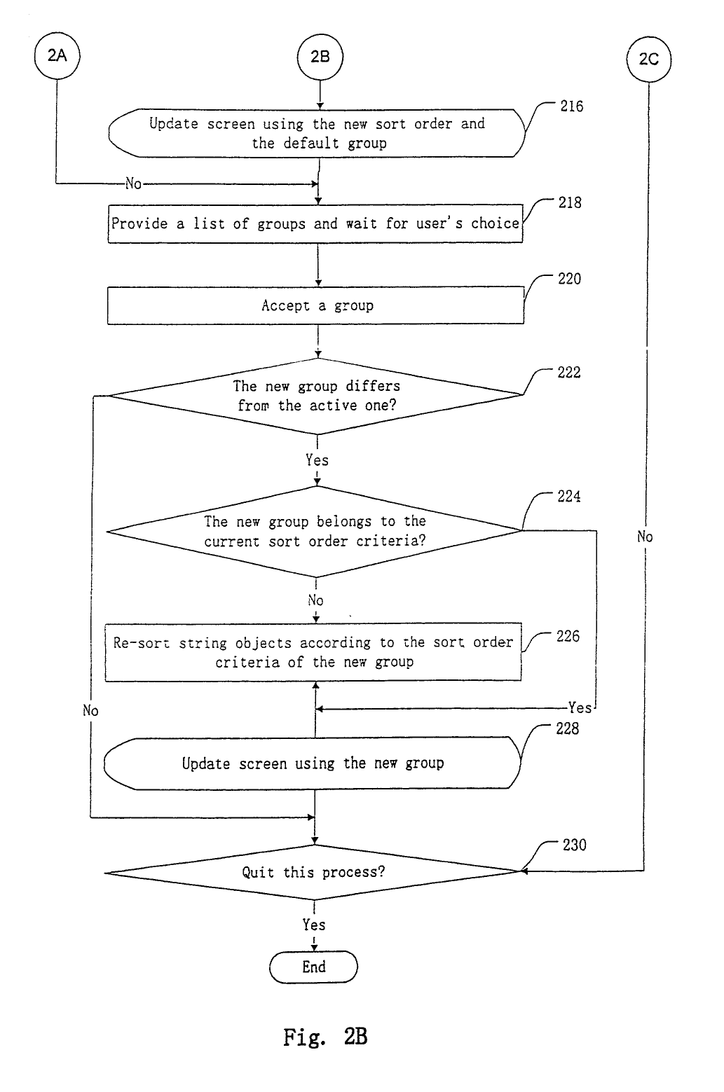

With reference now to FIGS. 2A and 2B, flow charts of a process for displaying string objects is depicted in accordance with another embodiment of the present invention.

The process begins at step 200 by designating a default sort order criteria and a default group. Next at step 202, the string objects are sorted as in step 104 of FIG. 1. At step 204, the string objects of the default group are displayed as in step 110 of FIG. 1. At step 206, a list of sort order criteria is provided and waits to be selected by user. After receiving a selection of the user at step 208, a determination is made as to whether the selected sort order criteria is different from the current order at step 210. If the order is not changed, the process skips to step 218. If the sort order is changed, then the process proceeds to the next step 212 where the groups corresponding to the new sort order are activate. Next at step 214, a default group is designated. Thereafter at step 216, the screen is updated using the new sort order and the default group. Next at step 218, a list of groups is provided and waits to be selected. The group selected by the user is received at step 220 and a determination is made at step 222 as to whether the selected group is different from the current group. If the group is not changed, the process skips to step 230. If the group has changed, the process proceeds to step 224 where a determination is made as to whether the selected group be longs to the current sort order criteria. If so, the process proceeds to step 228. If not, the string objects are re-sorted according to the sort order criteria of the selected group at step 226. There after at step 228, the screen is up dated using the new group. Next at step 230, a determination is made as to whether the process should be stopped. If so, the process stops. Otherwise, the process then returns to step 206 and waits for the next selection.

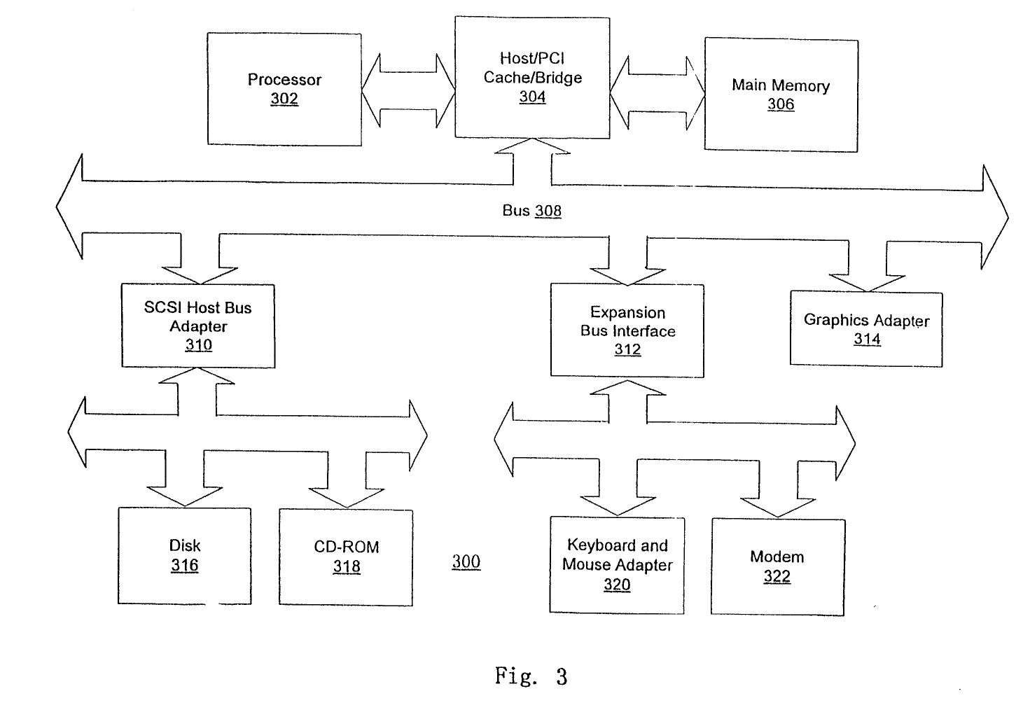

With reference now to FIG. 3, the block diagram illustrates an information displaying apparatus in which the present invention may be implemented. Information displaying apparatus 300 is an example of a personal computer. Information displaying apparatus 300 employs a peripheral component interconnect (PCI) local bus architecture. Processor 302 and main memory 306 are connected to PCI local bus 308 via PCI bridge 304. The SCSI host bus adapter 310 and the expansion bus interface 312 are connected to PCI local bus 308 by direct component connection. The graphics adapter 314 is connected to PCI local bus 308 by add-in boards inserted into expansion slots. The SCSI host bus adapter 310 provides a connection for hard disk 316 and CD-ROM 318. The expansion bus interface 312 provides a connection for a keyboard and mouse adapter 320 and modem 322. An operating system runs on process or 302 and is used to provide control for various components within information displaying apparatus 300 in FIG. 3. The operating system may be a commercially available operating system such as Windows 95, which is available from Microsoft Corporation. “Windows 95” is a trademark of Microsoft Corporation.

Those of ordinary skill in the art will appreciate that the hardware in FIG. 3 may vary depending on the implementation. Although the depicted example employs a PCI bus, other bus architectures such as Micro Channel and ISA may also be used. Other internal hardware or peripheral devices, such as LAN card, audio card, may be used in addition to the hardware depicted. Other operating systems, such as OS/2, UNIX and LINUX, may also be employed to control the apparatus 300. Although information displaying apparatus 300 depicted in FIG. 3 is a personal computer, other devices that are capable of displaying text information could also be used to implement the method of the present invent, such as personal digital assistant (PDA), smart phone or mobile phone.

The FIGS. 4A-4C are interfaces of the present invention, wherein the string objects are names in an address book. FIG. 4A illustrates that group identifiers of different sort order criteria may be displayed simultaneously. In this example, the group identifiers of stroke order (i.e. “ [symbol] ”, “ [symbol] ”, “ [symbol] ”, “ [symbol] ”, “ [symbol] ” are displayed together with the group identifiers of Pinyin order (i.e. “A-G”, “H-N”, “O-T”, “U-Z”). Those of ordinary skill in the art will appreciate that the string objects may be any list of text information, such as links of Internet addresses and file names.

The description of the present invention has been presented for the purpose of illustration, but is not intended to limit the invention in the form disclosed. Many modifications and variations will be apparent to those of ordinary skill in the art. For example, the groups of Pinyin may be “A-G”, “H-N”, “O-T”, “U-Z”, “0-9” and others, or “A-D”, “E-H”, “I-O”, “P-U”, “V-Z” and others. For stroke count order, the groups may be “1-5 strokes”, “6-9”, “10-14 ”,“15-20”, “above 20” and other. The rule of splitting Chinese characters may also be different, for example, Chinese characters may be split to 5 basic strokes or 10 basic strokes according to the direction and size of the strokes. The present invention may also be applied to other languages.

1. A method for displaying a plurality of string objects, consisting of the following steps:
selecting one of a plurality of sort order criteria;
sorting a plurality of said string objects based on the selected sort order of said string object; and
displaying a plurality of said string objects in selected sort order.

2. The method as defined in claim 1, where in an identifier is provided for each of said sort order criteria; a user may select one of the identifiers; if none of the identifiers is selected, then a default sort order is designated and a plurality of said string objects are sorted and displayed according to the default sort order criteria.

3. The method as defined in claim 2, where in the default sort order may be pre-selected by the user or the system or it may be that which was in place the last time that method was used or it may be decided by an algorithm.

4. The method as defined in claim 1, further comprising the following steps after the step of selecting the sort order criteria:
further dividing a plurality of said string objects into a plurality of groups;
selecting one of said groups;
displaying the string objects of the selected group in a manner that is different from the manner of displaying the string objects of other groups.

5. The method as defined in claim 1, further comprising the following steps after the step of selecting the sort order criteria:
further dividing a plurality of said string objects into a plurality of groups;
selecting one of said groups;
moving a cursor to the location of the string objects of the selected group.

6. The method as defined in claim 4, said different manner of displaying string objects comprise (but not limit to) one or more of blinking, changing the font, enlarging the size, highlighting or changing color of the string objects.

7. The method as defined in claim 4 or 5, where in an identifier is provided for each group; a user may select one of the identifiers; if none of the identifiers is selected, then a default group is designated, string objects of the default group are displayed in a manner that is different from the manner of displaying the string objects of other groups or the cursor is moved to the location of the string objects of the selected group.

8. The method as defined in claim 7, wherein said identifiers of groups that belong to different sort order criteria may be displayed simultaneously, the string objects are re-sorted if the selected group does not belongs to the current sort order criteria.

9. The method as defined in claim 7, where in the default group may be pre-selected by the user or the system or it may be that which was in place the last time that method was used or it may be decided by an algorithm.

10. The method as defined in claim 4, 5, or 6, wherein the number of groups is decided by the number of identifiers that can be displayed or the number of objects included in the groups.

11. The method as defined in any one of claim 1 to 5, wherein said sort order criteria comprise alphabet order, Pinyin order, Zhuyin order, stroke order, stroke count order, radical order, kana order or Korean character order.

12. The method as defined in any preceding claim, wherein said string objects may be one of personal data in an address book, links of Internet addresses, file names or other list of text.

13. An apparatus for displaying a plurality of string objects, comprising:
a storage means for storing a plurality of said string objects;
an input means for entering user commands;
a sorting means for responding to the sort order criteria entered by a user, retrieving a plurality of said string objects from said storage device, and sorting a plurality of said string objects based on the selected sort order of the string objects; and
a display means for displaying a plurality of said string objects in the selected sort order.

14. The apparatus as defined in claim 13, wherein an identifier is provided for each of said sort order criteria on said display means, a user may select one of the identifiers by said input means; if none of the identifiers is selected, then a default sort order is designated and a plurality of said string objects are sorted and displayed according to the default sort order criteria.

15. The apparatus as defined in claim 14, where in the default sort order may be pre-selected by the user or the system or it may be that which was in place the last time that method was used or it may be decided by an algorithm.

16. The apparatus as defined in claim 13, further comprising: a grouping means for further dividing said sorted string objects into a plurality of groups; selecting one of said groups; and displaying the string objects of the selected group in a manner that is different from the manner of displaying the string objects of other groups.

17. The apparatus as defined in claim 13, further comprising: a grouping means for further dividing said sorted string objects into a plurality of groups; selecting one of said groups; and moving a cursor to the location of string objects of selected group.

18. The apparatus as defined in claim 16, said different manner of displaying string objects comprise (but not limit to) one or more of blinking, changing the font, enlarging the size, highlighting or changing color of the string objects.

19. The apparatus as defined in claim 16 or 17, wherein an identifier is provided for each group on said display means, a user may select one of the identifiers; if none of the identifiers is selected, then a default group is designated, and only the string objects of the default group are displayed or the first string object of the default group is highlighted.

20. The apparatus as defined in claim 13, wherein said identifiers of groups that belong to different sort order criteria may be displayed simultaneously, the string objects are re-sorted if the selected group does not belongs to the current sort order criteria.

21. The apparatus as defined in claim 19, wherein the default group may be pre-selected by the user or the system or it may be that which was in place the last time that method was used or it may be decided by an algorithm.

22. The method as defined in claim 16, 17 or 18, wherein the number of groups is decided by the number of identifiers that can be displayed or the number of objects included in the groups.

23. The method as defined in anyone of claim 13 to 18, wherein said sort order criteria comprise alphabet order, Pinyin order, Zhuyin order, stroke order, stroke count order, radical order, kana order or Korean character order.

24. The apparatus as defined in any one of claim 13 to 23, wherein said string objects may be one of personal data in an address book, links of Internet addresses, file names or other list of text.

25. The apparatus as defined in any one of claim 13 to 24, wherein said apparatus is either a computer, a personal digital assistant (PDA), a mobile phone, a smart phone or other electrical device that is capable of displaying text information.
